(19) United States
(12) Patent Application Publication
(10) Pub. No.: US 2019/0019272 A1
(43) Pub. Date: Jan. 17, 2019

(54) NOISE REDUCTION FOR DIGITAL IMAGES

(71) Applicant: QUALCOMM Incorporated, San Diego, CA (US)

(72) Inventors: Shang-Chih Chuang, New Taipei City (TW); Jun Zuo Liu, Yunlin (TW); Xiaoyun Jiang, San Diego, CA (US)

(21) Appl. No.: 15/649,510

(22) Filed: Jul. 13, 2017

(51) Int. Cl. G06T 5/00

(52) U.S. Cl. CPC G06T 5/002; G06T 2207/20182

(57) ABSTRACT

Methods and apparatuses for image processing are disclosed. An example method may include receiving an image to be processed. The method may further include selecting a pixel of the image. The method may also include determining, for each of a plurality of directions through the selected pixel, a gradient in intensity based on the selected pixel and a set of one or more neighboring pixels along the corresponding direction. The method may further include determining, for each of the plurality of directions, if the set of one or more neighboring pixels is selected for adjusting the intensity of the selected pixel based on the corresponding determined gradient in intensity. The method may also include determining a noise reduction filter for the selected pixel based on the selected sets of one or more neighboring pixels. The method may further include applying the determined noise reduction filter to the selected pixel of the image.

### TECHNICAL FIELD

The present disclosure relates generally to processing digital images, and specifically to reducing noise in digital images.

### BACKGROUND

Many wireless communication devices (such as smartphones, tablets, and so on) and consumer devices (such as digital cameras, home security systems, and so on) use one or more cameras to capture images and video. When an image is captured, the captured information is processed before being saved or presented to a user for viewing. In processing an image, multiple filters may be applied to make the image more pleasing to the user.

Advances in image processing may be attributed to the application of greater numbers of, and more complex, filters to captured images. However, as the resolution and color depth of images increases, greater amounts of data are provided to such filters for processing, which may undesirably increase image processing times.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure are directed to methods and apparatuses for image processing. An example method may include receiving an image to be processed. The method may further include selecting a pixel of the image. The method may also include determining, for each of a plurality of directions through the selected pixel, a gradient in intensity based on the selected pixel and a set of one or more neighboring pixels along the corresponding direction. The method may further include determining, for each of the plurality of directions, if the set of one or more neighboring pixels is selected for adjusting the intensity of the selected pixel based on the corresponding determined gradient in intensity. The method may also include determining a noise reduction filter for the selected pixel based on the selected sets of one or more neighboring pixels. The method may further include applying the determined noise reduction filter to the selected pixel of the image.

In another example, a device for image processing is disclosed. The device may include an image signal processor configured to select a pixel of the image. The image signal processor may be further configured to determine, for each of a plurality of directions through the selected pixel, a gradient in intensity based on the selected pixel and a set of one or more neighboring pixels along the corresponding direction. The image signal processor may be further configured to determine, for each of the plurality of directions, if the set of one or more neighboring pixels is selected for adjusting the intensity of the selected pixel based on the corresponding determined gradient in intensity. The image signal processor may be further configured to determine a noise reduction filter for the selected pixel based on the selected sets of one or more neighboring pixels. The image signal processor may be further configured to apply the determined noise reduction filter to the selected pixel of the image.

In another example, a non-transitory computer-readable storage medium is disclosed. The non-transitory computer-readable storage medium may store one or more programs containing instructions that, when executed by one or more processors of a device, cause the device to receive an image to be processed. Execution of the instructions may further cause the device to select a pixel of the image. Execution of the instructions may also cause the device to determine, for each of a plurality of directions through the selected pixel, a gradient in intensity based on the selected pixel and a set of one or more neighboring pixels along the corresponding direction. Execution of the instructions may further cause the device to determine, for each of the plurality of directions, if the set of one or more neighboring pixels is selected for adjusting the intensity of the selected pixel based on the corresponding determined gradient in intensity. Execution of the instructions may also cause the device to determine a noise reduction filter for the selected pixel based on the selected sets of one or more neighboring pixels. Execution of the instructions may further cause the device to apply the determined noise reduction filter to the selected pixel of the image.

In another example, a device for processing an image is disclosed. The device includes means for receiving an image to be processed. The device also includes means for selecting a pixel of the image. The device further includes means for determining, for each of a plurality of directions through the selected pixel, a gradient in intensity based on the selected pixel and a set of one or more neighboring pixels along the corresponding direction. The device also includes means for determining, for each of the plurality of directions, if the set of one or more neighboring pixels is selected for adjusting the intensity of the selected pixel based on the corresponding determined gradient in intensity. The device further includes means for determining a noise reduction filter for the selected pixel based on the selected sets of one or more neighboring pixels. The device also includes means for applying the determined noise reduction filter to the selected pixel of the image.

### BRIEF DESCRIPTION OF THE DRAWINGS

The disclosure herein is illustrated by way of example, and not by way of limitation, in the figures of the accompanying drawings and in which like reference numerals refer to similar elements.

FIG. 1 is a block diagram of an example device that may be used to perform aspects of the present disclosure.

FIG. 2A is a block diagram of an example image signal processor.

FIG. 2B is a block diagram of example filters of an image signal processor.

FIG. 3 is an illustration depicting a processed image.

FIG. 4A is an illustration depicting a portion of an image.

FIG. 4B is an illustration depicting directions through a center pixel in the portion of the image depicted in FIG. 4A.

FIG. 5 is an illustrative flow chart depicting an example operation for processing an image using a noise reduction filter, in accordance with some aspects of the present disclosure.

FIG. 6 is an illustrative flow chart depicting an example operation for determining a noise reduction filter for a selected pixel of an image, in accordance with some aspects of the present disclosure.

FIG. 7 is an illustrative flow chart depicting an example operation for determining a gradient in intensity along a direction for a selected pixel of an image, in accordance with some aspects of the present disclosure.

FIG. 8 is an illustrative flow chart depicting an example operation for selecting a set of one or more neighboring pixels along the direction for adjusting the intensity of the selected pixel of the image, in accordance with some aspects of the present disclosure.

FIG. 9 is an illustrative flow chart depicting an example operation for determining a mask for the selected pixel of the image, in accordance with some aspects of the present disclosure.

FIG. 10 is an illustration depicting example masks for the selected pixel of the image based on the number of directions for which one or more neighboring pixels of the selected pixel are to be used in adjusting the intensity of the selected pixel.

FIG. 11A is an illustration depicting example masks for the selected pixel of the image based on which directions one or more neighboring pixels of the selected pixel are to be used in adjusting the intensity of the selected pixel.

FIG. 11B is an illustration depicting additional example masks for the selected pixel of the image based on which directions one or more neighboring pixels of the selected pixel are to be used in adjusting the intensity of the selected pixel.

FIG. 12 is an example logic diagram for determining if one or more neighboring pixels of the selected pixel of the image along a direction are to be used in adjusting the intensity of the selected pixel.

FIG. 13 is an example logic diagram for determining a noise reduction filter to be applied to a selected pixel of the image.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

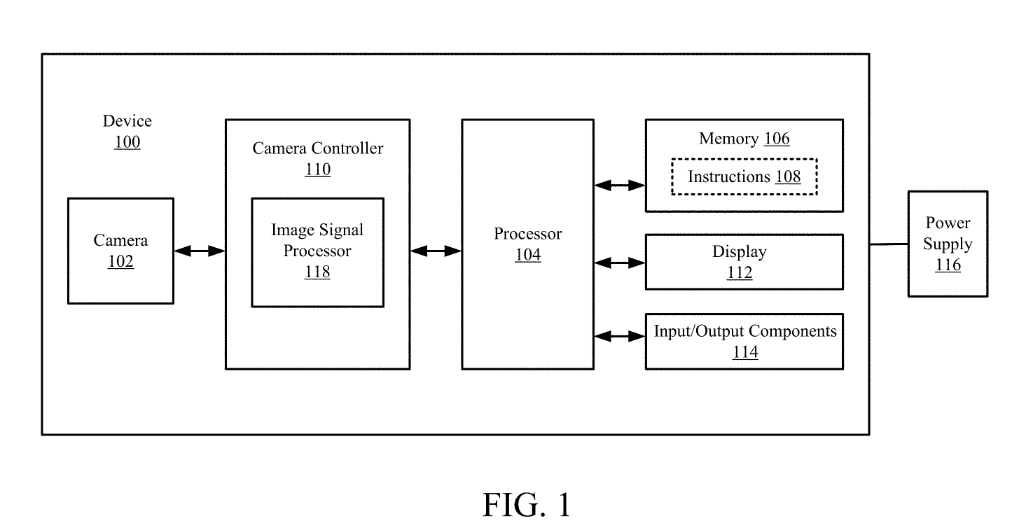

FIG. 1 is a block diagram of an example device 100 that may be used to perform aspects of the present disclosure. The device 100 may be any suitable device capable of processing captured images or video including, for example, wired and wireless communication devices (such as camera phones, smartphones, tablets, security systems, dash cameras, laptop computers, desktop computers, and so on) and digital cameras (including still cameras, video cameras, and so on). The example device 100 is shown in FIG. 1 to include at least one or more cameras 102, a processor 104, a memory 106 storing instructions 108, a camera controller 110, a display 112, and a number of input/output (I/O) components 114. The device 100 may include additional features or components not shown. For example, a wireless interface, which may include a number of transceivers and a baseband processor, may be included for a wireless communication device.

The camera 102 may include the ability to capture individual images and/or to capture video (such as a succession of captured images). The camera 102 may include one or more image sensors (not shown for simplicity) for capturing an image and providing the captured image to the camera controller 110.

The memory 106 may be a non-transient or non-transitory computer readable medium storing computer-executable instructions 108 to perform all or a portion of one or more operations described in this disclosure. The device 100 may also include a power supply 116, which may be coupled to or integrated into the device 100.

The processor 104 may be any one or more suitable processors capable of executing scripts or instructions of one or more software programs (such as instructions 108) stored within memory 106. In some aspects of the present disclosure, the processor 104 may be one or more general purpose processors that execute instructions 108 to cause the device 100 to perform any number of different functions or operations. In additional or alternative aspects, the processor 104 may include integrated circuits or other hardware to perform functions or operations without the use of software. While shown to be coupled to each other via the processor 104 in the example of FIG. 1, the processor 104, the memory 106, the camera controller 110, the display 112, and the I/O components 114 may be coupled to one another in various arrangements. For example, the processor 104, the memory 106, the camera controller 110, the display 112, and the I/O components 114 may be coupled to each other via one or more local buses (not shown for simplicity).

The display 112 may be any suitable display or screen allowing for user interaction and/or to present items (such as captured images and video) for viewing by the user. In some aspects, the display 112 may be a touch-sensitive display. The I/O components 114 may be or include any suitable mechanism, interface, or device to receive input (such as commands) from the user and to provide output to the user. For example, the I/O components 114 may include (but are not limited to) a graphical user interface, keyboard, mouse, microphone and speakers, and so on. The device 100 may further include motion detection sensors, such as a gyroscope, accelerometer, compass, and so on, to determine a motion and orientation of the device 100.

The camera controller 110 may include a number of image signal processors 118 to process captured images or video provided by the camera 102. In some example implementations, the camera controller 110 may receive from a sensor of camera 102 a raw image frame that requires some processing before presentation for viewing by the user, and may apply one or more filters to the raw image frame to ready the image for viewing, for example, on the display 112. Example filters may include noise reduction filters, edge enhancement filters, gamma correction filters, light balance filters, color contrast filters, and so on. For example, a captured image from a camera sensor may be a digital negative of the image to be viewed. The captured image may alternatively be in a data format that is not readily viewable, for example, on the display 112.

In some aspects of the present disclosure, one or more of the image signal processors 118 may execute instructions from a memory (such as instructions 108 from the memory 106 or instructions stored in a separate memory coupled to the image signal processor 118) to process a captured image provided by the camera 102. In some other aspects of the present disclosure, one or more of the image signal processors 118 may include specific hardware to apply one or more of the filters to the captured image. For example, one of the image signal processors 118 may include an integrated circuit to apply a filter to a captured image for noise reduction. One or more of the image signal processor 118 may also include a combination of specific hardware and the ability to execute software instructions to process a captured image.

When a device (such as device 100 in FIG. 1) captures an image, the captured information from a camera sensor of the device is processed. Additionally, a device may process a previously captured image. For example, an image may be sharpened, may be de-noised, may be blurred, may be color corrected, and so on when being processed. In processing an image, the device may apply one or more filters to the image.

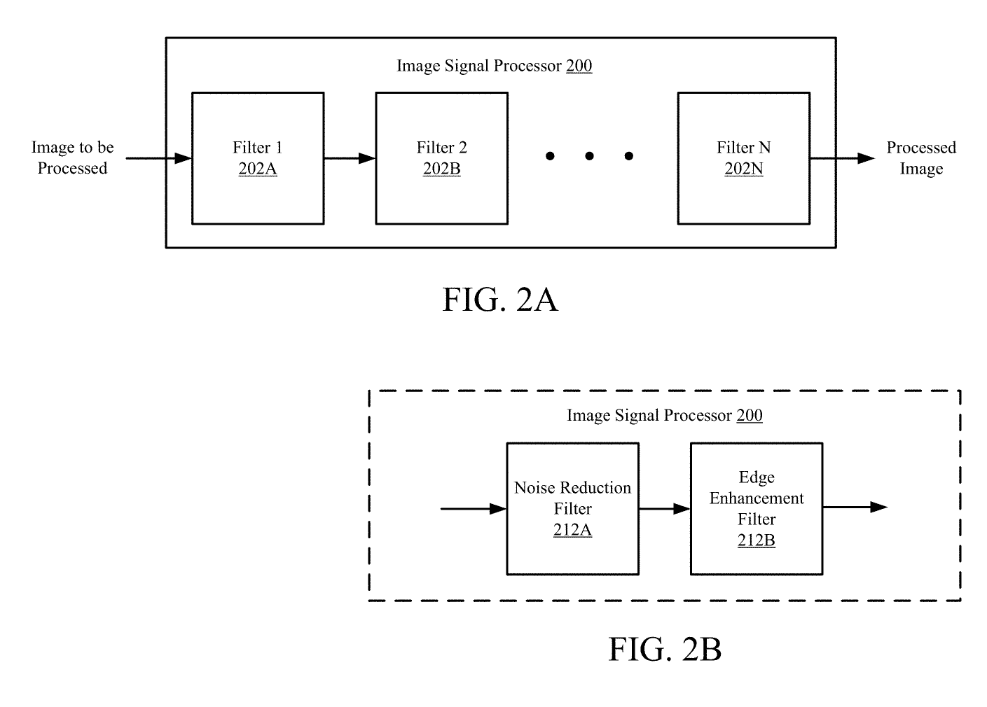

FIG. 2A is a block diagram of an example image signal processor 200 that may be one implementation of one or more of the image signal processors 118 of FIG. 1. The image signal processor 200 may be a single thread (or single core) processor including a sequence of filters 202A-202N. In some example implementations, filter 1 (202A) may be a noise reduction filter, filter 2 (202B) may be an edge enhancement filter, and filter N (202N) may be a final filter to complete processing the captured image frame.

FIG. 2B is a block diagram of example filters of the image signal processor 200 of FIG. 2A. The image signal processor 200 is shown to include a noise reduction filter 212A preceding an edge enhancement filter 212B. The noise reduction filter 212A may be a smoothing filter or a blending filter, and the edge enhancement filter 212B may enhance the contrast between objects in an image. In other implementations, the image signal processor 200 may include additional filters not shown in FIG. 2B.

When processing an image, many existing noise reduction filters process image data multiple times, for example, by iteratively filtering the image data. Although “one-shot” smoothing filters may be used to avoid processing the image data multiple times, these smoothing filters may undesirably blur features of the image and generate undesired artifacts. For example, lines or contours in images may be lost or reduced when processed using a blending or blurring smoothing filter.

To reduce image processing times and image blurring, some devices may implement a bilateral filter to reduce noise. A bilateral filter is a non-linear, one-shot filter that, when processing a selected pixel of an image, uses information regarding the intensities of neighboring pixels to adjust an intensity of the selected pixel. The distance between the neighboring pixel and the selected pixel is inversely related to the neighboring pixel's effect on the intensity of the selected pixel (such as a Gaussian distribution), and the closeness of the neighboring pixel's intensity to the selected pixel's intensity is directly related to the neighboring pixel's effect on the selected pixel (such as a center pixel). As a result, neighboring pixels that are close in distance or similar in intensity to the selected pixel may have a greater effect on the selected pixel than neighboring pixels that are further from or less similar in intensity to the selected pixel.

An example operation of a bilateral filter on a pixel of an image may be expressed by Equation (1) below:

$${I}_{filtered} ( x ) = \frac{{\sum }_{{x}_{i} ∈ Ω} I ( {x}_{i} ) {w}_{l} ( ‖ I ( {x}_{i} ) - I ( x ) ‖ ) {w}_{d} ( ‖ {x}_{i} - x ‖ )}{{\sum }_{{x}_{i} ∈ Ω} {w}_{l} ( ‖ I ( {x}_{i} ) - I ( x ) ‖ ) {w}_{d} ( ‖ {x}_{i} - x ‖ )} \qquad ( 1 )$$

where I_{filtered} represents the intensities of the filtered image, I_{filtered}(x) represents the intensity of a selected pixel x of the filtered image, and Ω is the portion, window, or mask of the image I (such that the pixels within the mask Ω are used to determine the intensity of selected pixel x). The term xᵢ represents a neighboring pixel of the selected pixel x within the mask Ω, the term w_{d} is a spatial function to reduce the effect of a neighboring pixel xᵢ on the selected pixel x as the distance of xᵢ from x (∥xᵢ−x∥) increases, and the term w₁ is a range function to reduce the effect of a neighboring pixel xᵢ on the selected pixel x as the difference in intensities between xᵢ and x (∥I(xᵢ)−I(x)∥) increases.

A bilateral filter may damage gradients in an image. Edges may become more jagged and more harsh than preferred by a user, for example, because some pixels are adjusted more by neighboring pixels than others (so that some pixels may appear to be outliers along an edge and the edge may not appear smooth or natural). Additionally, spots or slight differences in smoothness may become unintentionally amplified, for example, because differences in intensities may be summed from many neighboring pixels to amplify a blemish so that the change in gradient is unpleasing to a user. These undesired artifacts may be further amplified by edge enhancement filters. For one example, a person's skin, which in general is smooth, has small variations, such as minor blemishes, spots, and undulations. Such variations may be amplified by a typical bilateral filter, thereby causing undesired artifacts in an image. For another example, edges of a person's face (such as by the eyelids, nostrils or other facial features) may become jagged after bilateral filtering, thereby causing further undesired artifacts in an image.

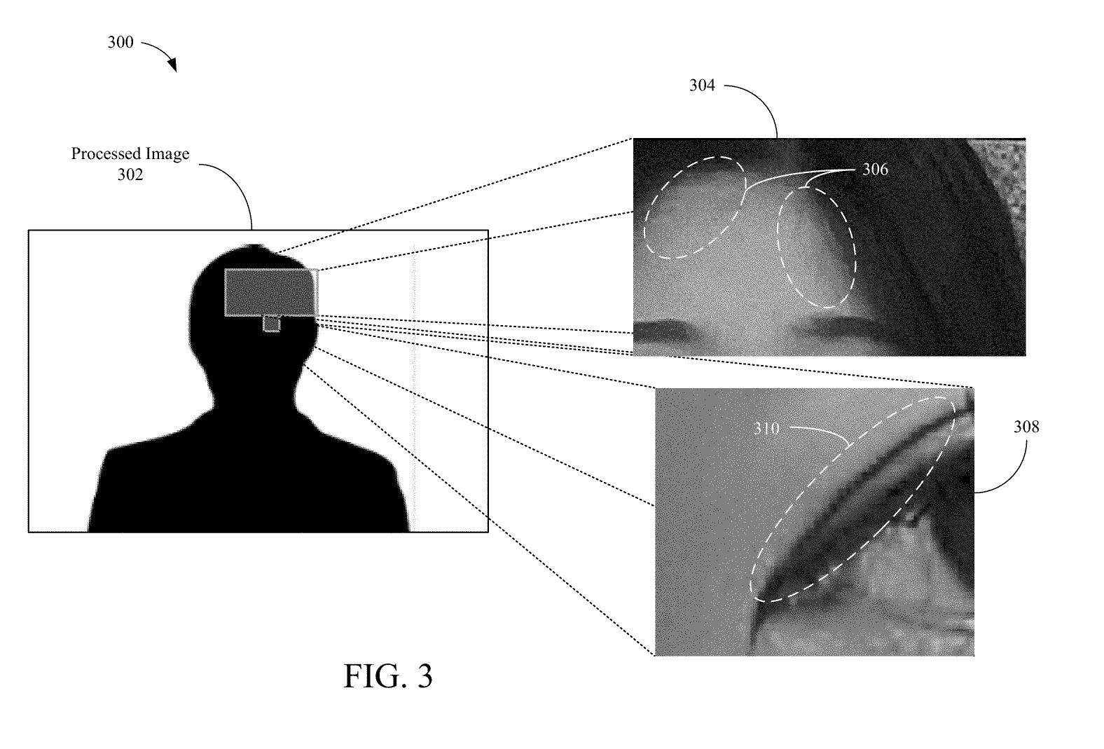

FIG. 3 is an illustration 300 depicting a processed image 302. The processed image 302 is shown to include image portions 304 and 308 having unwanted artifacts 306 and 310, respectively, resulting from a bilateral noise reduction filter. The first image portion 304 shows a forehead of a person in the image 302. As shown, a bilateral noise reduction filter may cause unwanted increases in existing minor undulations, for example, resulting in splotches 306 on the person's forehead in the processed image 302. The second image portion 308 shows a portion of the eyelid of the person in the image 302. As shown, the bilateral noise reduction filter may cause an unwanted jagged edge 310 along the eyelid of the person in the image 302.

In accordance with aspects of the present disclosure, the device 100 may employ a noise reduction filter (such as the noise reduction filter 212A in FIG. 2B) that does not generate unwanted artifacts (such as artifacts 306 and 310 in the image 302 of FIG. 3) caused by a bilateral filter. In some implementations, the noise reduction filter 212A uses directions of intensity gradients through a center pixel of a mask or window to adjust the intensity of the center pixel. For example, if the gradient along a direction through the center pixel is consistent and within a threshold, then neighboring pixels along the direction may be used to adjust the intensity of the center pixel. Conversely, if the gradient along the direction through the center pixel is greater than the threshold or is inconsistent, then the neighboring pixels along the direction might not be used to adjust the intensity of the center pixel. Adjusting the center pixel's intensity may therefore depend on the number of directions or on the directions for which the gradient is less than the threshold and is consistent. In some aspects, the threshold may be adjustable and may be based on the intensity of the center pixel. In other aspects, the threshold may be adjustable and may be based on intensities of pixels within the mask for the center pixel.

In implementations for which the intensity of a pixel is determined by its luminance, the device may determine a gradient of the luminance for neighboring pixels and a center pixel along a direction. The gradient may be consistent if the luminance increases along the direction or decreases along the direction (without an inflection point). While some examples of intensity are provided, the present disclosure should not be limited to the examples of intensity provided herein.

In some example implementations, the noise reduction filter 212A may be linear. Additionally or alternatively, the noise reduction filter 212A may be Laplacian based (such as by using a Laplacian based kernel or mask in processing the image). As a result, the noise reduction filter 212A may be a one-shot filter implemented in hardware, software, or a combination of both. In addition to the noise reduction filter 212A reducing unwanted artifacts caused by a bilateral filter, applying the noise reduction filter 212A to images during processing may be more efficient than applying a bilateral filter to the images (e.g., as a result of the noise reduction filter being linear), which in turn may reduce computing resources and image processing times while increasing the ease of implementation.

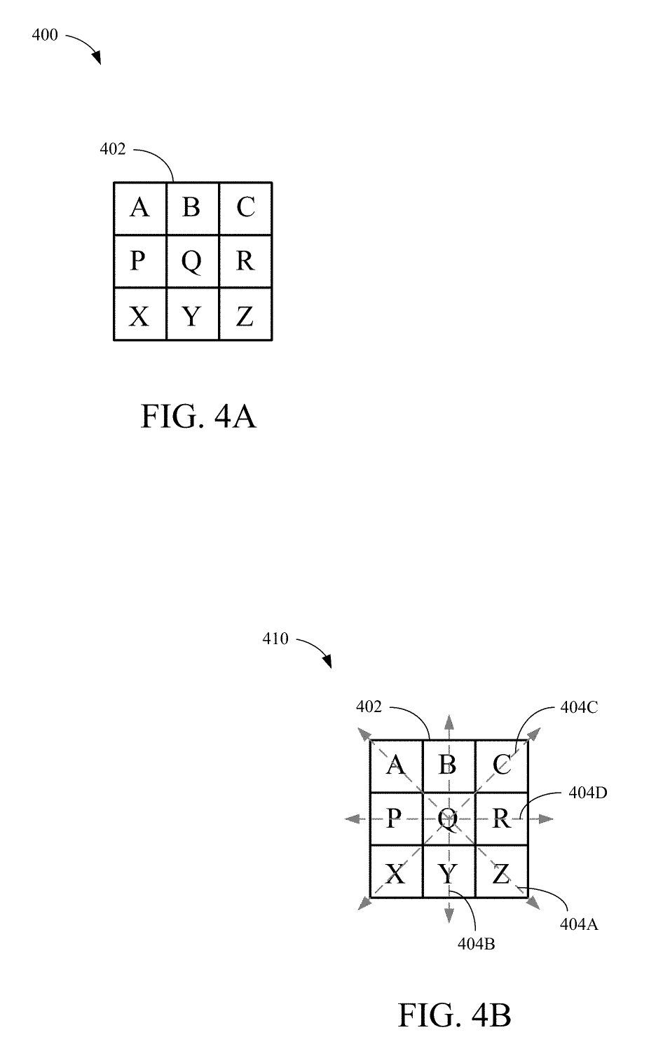

FIG. 4A is an illustration 400 depicting an example portion 402 of an image. The example portion 402 may be used for determining the noise reduction filter for a selected pixel of the image. As shown, the portion 402 is a 3×3 mask or window of the image, and includes 9 pixels, and the selected pixel (e.g., the pixel to be processed in portion 402) is the center pixel Q. The neighboring pixels of the center pixel Q are pixel A, pixel B, pixel C, pixel P, pixel R, pixel X, pixel Y, and pixel Z. Although the portion 402 is depicted as a 3×3 mask in the example of FIG. 4A, it is to be understood that aspects of the present disclosure may be applied to other size masks. For example, the mask may be smaller so as to include less directions through the center pixel. Alternatively, the mask may be larger so that some neighboring pixels do not border the center pixel. Thus, the present disclosure should not be limited to the examples provided herein.

FIG. 4B is an illustration 410 depicting directions through the center pixel (pixel Q) in the image portion 402 depicted in FIG. 4A. In some example implementations, the directions include one or more of direction 404A (including pixel A, pixel Q, and pixel Z), direction 404B (including pixel B, pixel Q, and pixel Y), direction 404C (including pixel C, pixel Q, and pixel X), and direction 404D (including pixel P, pixel Q, and pixel R). As shown, each of the directions 404A-404D passes through the center pixel Q.

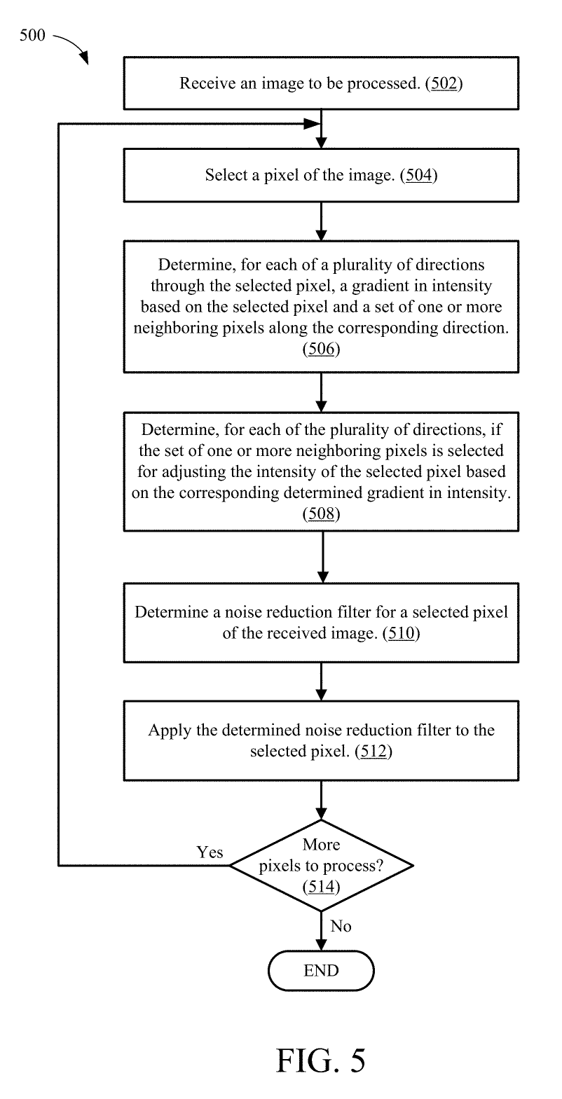

FIG. 5 is an illustrative flow chart depicting an example operation 500 for processing an image using a noise reduction filter, in accordance with some aspects of the present disclosure. Although described below with respect to the image signal processor 118 of FIG. 1, the example operation 500 may be performed by other suitable image signal processors (such as the image signal processor 200 of FIG. 2A) or by other suitable components of the device 100 (such as the processor 104 executing instructions 108 stored in the memory). To begin processing, the image signal processor 118 may receive an image to be processed (502). In some implementations, the image may be received from a camera of the device 100 (such as the camera 102). In other implementations, the image may be retrieved from a memory (such as from the memory 106 of device 100) or other device component (such as the I/O components 114, including an input port, network attached storage, and so on).

The image signal processor 118 may select a pixel of the image (504), and then determine, for each of a plurality of directions through the selected pixel, a gradient in intensity based on the selected pixel and a set of one or more neighboring pixels along the corresponding direction (506). The image signal processor 118 may then determine, for each of the plurality of directions, if the set of one or more neighboring pixels is selected for adjusting the intensity of the selected pixel based on the corresponding determined gradient in intensity (508).

The image signal processor 118 may determine a noise reduction filter for a selected pixel of the received image (510). While the noise reduction filter is described below in terms of a pixel of the image, the image may be processed at different levels of granularity. For one example, a noise reduction filter may be determined for each color of the pixel (e.g., if using RGB values). For another example, the noise reduction filter may be determined for and applied to a plurality of pixels.

The image signal processor 118 may apply the determined noise reduction filter to the selected pixel in order to adjust the selected pixel's intensity (512). In some example implementations, the image signal processor 118 may apply a mask centered at the selected pixel to selectively use the intensities of one or more neighboring pixels to determine the intensity of the selected pixel.

The image signal processor 118 may determine if more pixels of the image are to be processed (514). If more pixels are to be processed, operations may continue at 504, for example, with the image signal processor 118 selecting a new pixel and determining a noise reduction filter for a next selected pixel. If no more pixels are to be processed (514), the operation 500 ends. Thereafter, the image signal processor 118 may apply another filter to the received image (such as the edge detection filter 212B depicted in FIG. 2B).

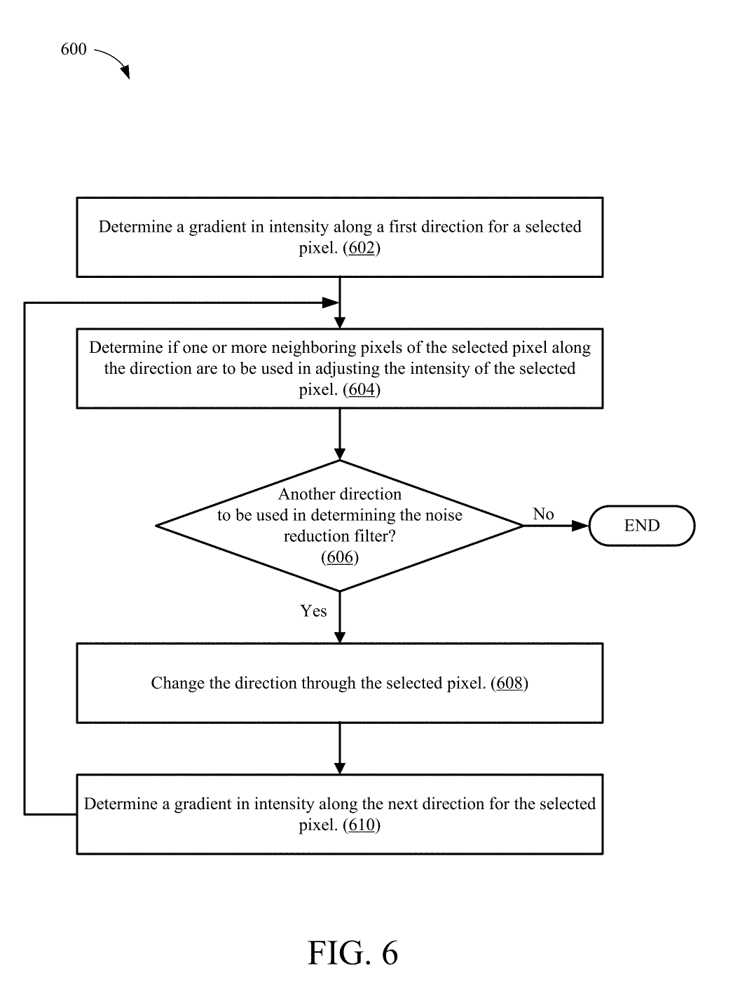

FIG. 6 is an illustrative flow chart depicting an example operation 600 for determining a noise reduction filter for the selected pixel of an image being processed. In some aspects, the example operation 600 may be one implementation of steps 506-510 of the example operation 500 depicted in FIG. 5. First, the image signal processor 118 may determine a gradient in intensity along a first direction for the selected pixel (602). As mention above, the noise reduction filter may depend on a gradient in intensity along a direction for the pixel. Because the intensity of a pixel may be expressed as a luminance of the pixel, determining a gradient in intensity may include determining differences in luminances between pixels (such as neighboring pixels and the pixel being processed).

The image signal processor 118 may determine if one or more neighboring pixels of the selected pixel along the first direction are to be used in adjusting or determining the intensity of the selected pixel (604). For example, if the first direction is the direction 404A of FIG. 4B and the selected pixel is pixel Q, the image signal processor 118 may determine if the intensity of neighboring pixel A and/or the intensity of neighboring pixel Z is to be used to adjust or determine the intensity of pixel Q.

The image signal processor 118 may determine if another direction is to be used in determining the noise reduction filter (606). For example, if steps 602 and 604 are performed for a first direction (such as the direction 404A depicted in FIG. 4B), then the image signal processor 118 may determine that similar operations are to be performed for another direction (such as the direction 404B depicted in FIG. 4B). If the image signal processor 118 determines that no other directions are to be used (as tested at 606), then the operation 600 ends. Conversely, if the image signal processor 118 determines that another direction is to be used (as tested at 606), the image signal processor 118 may change the direction through the selected pixel (608), and may then determine a gradient in intensity along the next direction for the selected pixel (610). The operation 600 may then return to 604.

It is noted that operations of steps 606, 608, and 610 are described above as being performed sequentially for a number of different directions. In other implementations, the image signal processor 118 may perform the operations of steps 606, 608, and 610 for multiple directions concurrently.

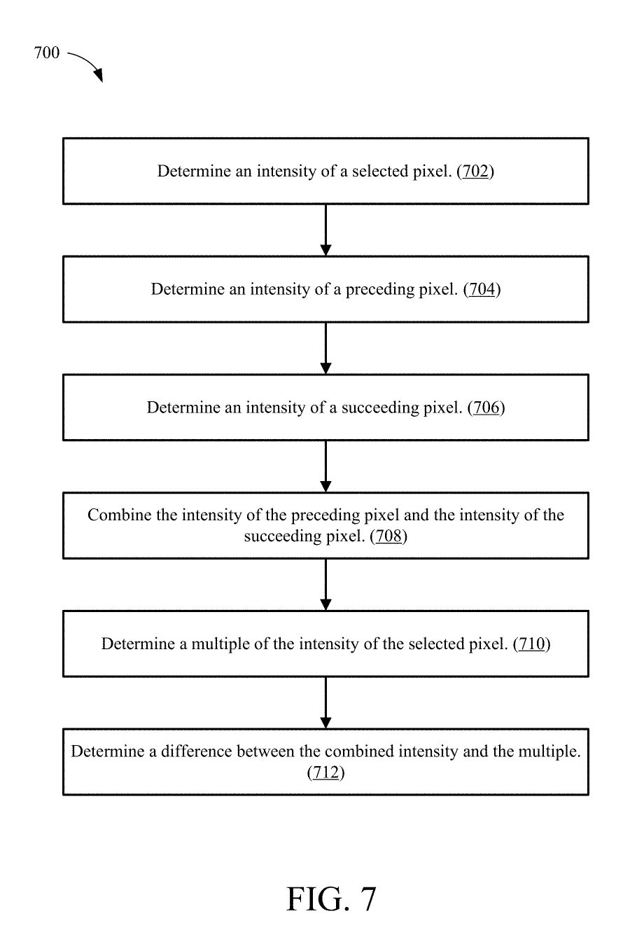

FIG. 7 is an illustrative flow chart depicting an example operation 700 for determining a gradient in intensity along a direction for the selected pixel. In some aspects, the example operation 700 may be one implementation of step 602 of the example operation 600 depicted in FIG. 6. First, the image signal processor 118 may determine an intensity of the selected pixel to be processed (702). For example, if determining luminances for a first direction (such as direction 404A), the image signal processor 118 may determine a luminance of pixel Q in the image portion 402. The image signal processor 118 may also determine an intensity of a pixel preceding pixel Q (704). In the image portion 402, along direction 404A, a preceding pixel of pixel Q may be pixel A or pixel Z. In other implementations, the preceding pixel may lie farther away from pixel Q along direction 404A than pixel A or pixel Z (thus being outside the illustrated 3×3 mask associated with the image portion 402).

The image signal processor 118 may also determine an intensity of a pixel succeeding pixel Q (706). For example, if the preceding pixel is pixel A, the succeeding pixel may be pixel Z. In other implementations, the succeeding pixel may also lie farther away from pixel Q along direction 404A than pixel A or pixel Z. While the example operation 700 depicts determining intensities in steps 702, 704 and 706 in sequence, one or more of the intensities may be determined concurrently, or in any other suitable order. Thus, the present disclosure should not be limited to the examples provided herein.

Once the intensity of the preceding pixel and the intensity of the succeeding pixel are determined (704 and 706), the image signal processor 118 may combine the intensity of the preceding pixel and the intensity of the succeeding pixel (708). For example, the image signal processor 118 may add the two intensities or combine the intensities in other ways. The image signal processor 118 may then determine a multiple of the intensity for pixel Q (710). In some aspects, the image signal processor 118 may determine two times the intensity of pixel Q. In other aspects, the image signal processor 118 may determine other integer or non-integer multiples of the intensity during the example operation. All or a portion of combining the intensities (708) and determining a multiple of the intensity (710) may be performed concurrently or sequentially.

The image signal processor 118 may determine the gradient along the direction to be a difference between the combined intensity and the determined multiple (712). For example, if the multiple is two times the intensity of pixel Q and the combination is the intensity of pixel A plus the intensity of pixel Z, then an example gradient (G₁) may be expressed by Equation (2) below:

$${G}_{1} = {\vec{D}}_{x}^{2} \times [ \begin{matrix}I ( A ) \\ I ( Q ) \\ I ( Z )\end{matrix} ] , wherein {\vec{D}}_{x}^{2} = [ 1 , - 2 , 1 ] \qquad ( 2 )$$

Expanding the cross-product of Equation (2), the example gradient in intensity (such as the luminance) along direction 404A of FIG. 4B may be expressed by Equation (3) below:

G₁=(I(A)+I(Z))−2*I(Q) (3)

\vec{D}ₓ²=[1, −2,1] is a one-dimensional Laplacian based kernel, as it may be used to determine a divergence of the gradient along a direction in Euclidian space for the image being processed. However, other kernels may be used in other implementations, and the present disclosure should not be limited to the provided example.

Continuing the example for Equation (2) for the other directions 404B, 404C, and 404D of the mask associated with the image portion 402 of FIG. 4B, the corresponding example gradients G₂, G₃, and G₄ may be expressed by Equations (4), (5), and (6), respectively, below:

$$\begin{matrix}{G}_{2} = {\vec{D}}_{x}^{2} \times [ \begin{matrix}I ( B ) \\ I ( Q ) \\ I ( Y )\end{matrix} ] , wherein {\vec{D}}_{x}^{2} = [ 1 , - 2 , 1 ] & ( 4 ) \\ {G}_{3} = {\vec{D}}_{x}^{2} \times [ \begin{matrix}I ( C ) \\ I ( Q ) \\ I ( X )\end{matrix} ] , wherein {\vec{D}}_{x}^{2} = [ 1 , - 2 , 1 ] & ( 5 ) \\ {G}_{4} = {\vec{D}}_{x}^{2} \times [ \begin{matrix}I ( P ) \\ I ( Q ) \\ I ( R )\end{matrix} ] , wherein {\vec{D}}_{x}^{2} = [ 1 , - 2 , 1 ] & ( 6 )\end{matrix}$$

Expanding the cross-product of Equation (4), Equation (5), and Equation (6), the example gradients of the intensity along directions 404B, 404C, and 404D may be expressed by Equation (7), Equation (8), and Equation (9), respectively, below:

G₂=(I(B)+I(Y))−2*I(Q) (7)

G₃=(I(C)+I(X))−2*I(Q) (8)

G₄=(I(P)+I(R))−2*I(Q) (9)

While all four directions through center pixel Q for the mask associated with the image portion 402 is shown in the example, the image signal processor 118 may be configured to determine gradients for more or less directions. For example, the image signal processor 118 may only determine gradients for two directions, such as gradients G₂ and G₄. In another example, the image signal processor 118 may determine gradients for more than four directions, where the mask is larger than 3×3 pixels. In further example implementations, the image signal processor 118 may determine gradients for a portion of directions to focus on gradients in a specific direction. For example, the image signal processor 118 may determine gradients for directions 404A and 404B (gradients G₁ and G₂, respectively). Additionally or alternatively, while equations (2) and (4)-(6) show kernel \vec{D}ₓ² to be the same for determining each gradient, the kernel may differ or be adjusted based on the direction for which a gradient is being determined.

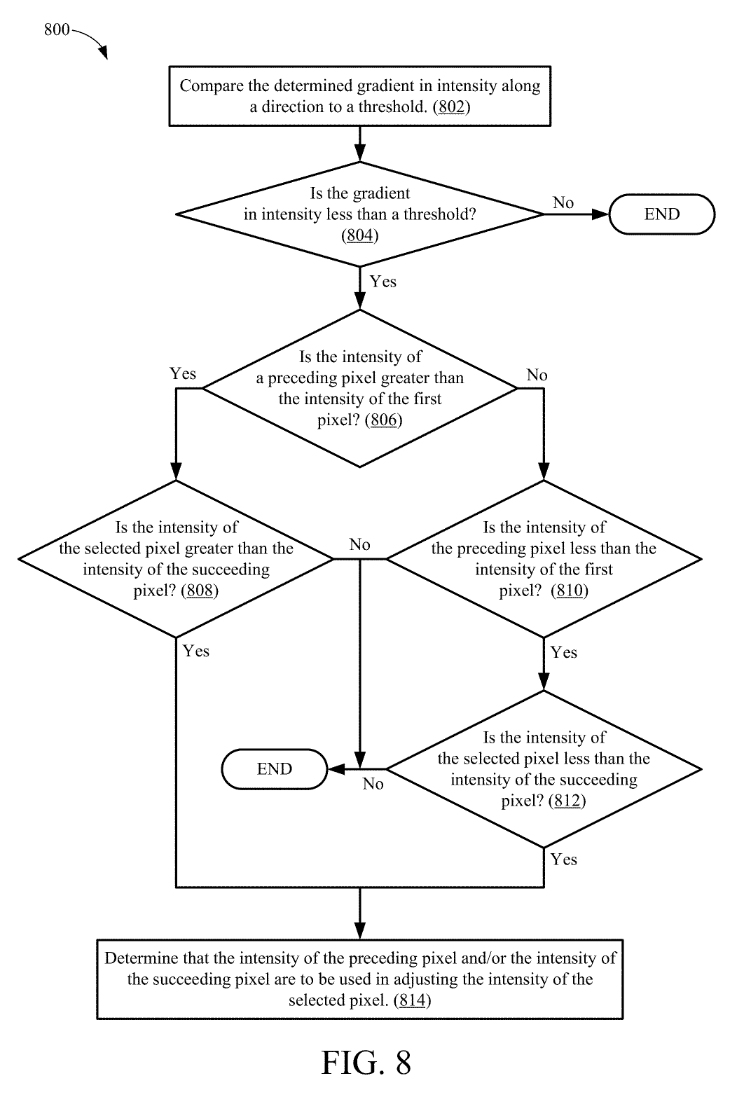

FIG. 8 is an illustrative flow chart depicting an example operation 800 for determining if one or more neighboring pixels along a direction for a selected pixel are to be used in adjusting or determining the intensity of the selected pixel, in accordance with some aspects of the present disclosure. For example, if the direction is 404A of FIG. 4B, the selected pixel is pixel Q, and the intensity is a luminance measurement, then the example operation 800 may be used to determine if the luminance of neighboring pixel A and/or the luminance of neighboring pixel Z is to be used to adjust or determine the luminance of pixel Q.

The image signal processor 118 may compare the determined gradient in intensity along a direction (such as a gradient determined by the example operation 700 of FIG. 7) to a threshold (802). The threshold may be determined by any means. For example, the threshold may be user defined, may be set by the device manufacturer, may be determined by the device 100 based on previous performance of the noise reduction filter, or may be determined by the device based on the image to be processed. The threshold may also be fixed or adjustable. In some example implementations where the threshold is adjustable, the threshold may be adjusted based on the intensity of a pixel being processed. For example, if the pixel being processed is pixel Q, the threshold may be expressed by Equation (10) below:

Threshold=E*I(Q)+H (10)

where I(Q) is the intensity of pixel Q, E is a factor less than one so that E*I(Q) is less than I(Q), and H is an optional offset or baseline for the threshold. Thus, the minimum threshold may be the offset (such as if I(Q)=0). Factor E and/or optional offset H may be defined by the device. For example, the values may be set by the manufacturer or the user. Values E and/or H may also be adjustable based on the filter or the image to be processed.

If the gradient in intensity is not less than the threshold (804), the image signal processor 118 may determine that the gradient is too large for the direction. For example, a large gradient may indicate that an edge intersects the pixels along the direction. Therefore, the image signal processor 118 might not use the intensity of the preceding pixel and the intensity of the succeeding pixel in adjusting or determining the intensity of the selected pixel to prevent creating a jagged edge (such as shown by artifact 310 in FIG. 3). If the gradient is too large (greater than the threshold), the image signal processor 118 may determine that the one or more neighboring pixels along the direction are not to be used in adjusting the intensity of the selected pixel, and the example process ends.

If the gradient in intensity is less than the threshold, as tested in 804, the image signal processor 118 may determine if the intensity of a pixel preceding the selected pixel is greater than the intensity of the selected pixel (806). For example, if the selected pixel is pixel Q of the mask associated with the image portion 402 and the direction is the direction 404A of FIG. 4B, the preceding pixel may be pixel A or pixel Z. Assuming pixel A is the preceding pixel, the image signal processor 118 may determine if the intensity of pixel A is greater than the intensity of pixel Q.

If the intensity of the preceding pixel is greater than the intensity of the selected pixel (806), the image signal processor 118 may also determine if the intensity of the selected pixel is greater than the intensity of the succeeding pixel (808). Continuing the previous example, if the image signal processor 118 determines that the intensity of pixel A is greater than the intensity of pixel Q, the image signal processor 118 determines if the intensity of pixel Q is greater than the intensity of pixel Z.

If the intensity of the selected pixel is greater than the intensity of the succeeding pixel (808), the image signal processor 118 may determine that the intensity of the preceding pixel and/or the intensity of the succeeding pixel are to be used in adjusting or determining the intensity of the selected pixel (814). Conversely, if the intensity of the selected pixel is not greater than the intensity of the succeeding pixel (808), the image signal processor 118 determines that the neighboring pixels of the selected pixel (such as the preceding pixel and the succeeding pixel) are not to be used in adjusting or determining the intensity of the selected pixel.

If the intensity of the selected pixel is not greater than the intensity of the succeeding pixel (808), then the intensity of the selected pixel is either equal to or less than the intensity of the succeeding pixel. If the intensities are equal, then the intensity of the preceding pixel is different than the same intensities of the selected pixel and the succeeding pixel. Such difference in intensities may indicate that a small edge may exist in the image somewhere by the preceding pixel and the selected pixel. Therefore, the image signal processor 118 might not use the intensity of the preceding pixel and the intensity of the succeeding pixel in adjusting or determining the intensity of the selected pixel to prevent creating splotches (such as shown by artifact 306 in FIG. 3). If the intensity of the selected pixel is less than the intensity of the succeeding pixel (808), then the intensity of the selected pixel is the least among the three pixels and the selected pixel is an inflection point (local minimum) in intensity. Thus, the image signal processor 118 may determine that the gradient is not consistent and therefore not use the neighboring pixels along the direction to determine or adjust the intensity of the selected pixel.

Returning to step 806, if the intensity of the preceding pixel is not greater than the intensity of the selected pixel, the image signal processor 118 determines if the intensity of the preceding pixel is less than the intensity of the selected pixel (810). If the intensity of the preceding pixel is not less than the intensity of the selected pixel, then the intensities are equal. Equal intensities may indicate that the gradient is not consistent. Therefore, the image signal processor 118 might not use the intensity of the preceding pixel and the intensity of the succeeding pixel in adjusting or determining the intensity of the selected pixel to prevent creating splotches (such as shown by artifact 306 in FIG. 3). Hence, if the intensities are equal (810), the example operation 800 ends.

If the intensity of the preceding pixel is less than the intensity of the selected pixel (810), the image signal processor 118 determines if the intensity of the selected pixel is less than the intensity of the succeeding pixel (812). If the intensity of the selected pixel (which is greater than the intensity of the preceding pixel) is less than the intensity of the succeeding pixel, the image signal processor 118 determines that the intensity of the preceding pixel and/or the intensity of the succeeding pixel are to be used in adjusting or determining the intensity of the selected pixel (814). If the intensity of the selected pixel is not less than the intensity of the succeeding pixel, then either the intensities are equal or the selected pixel is an inflection point (local maximum) in intensity. Thus, the image signal processor 118 may determine that the gradient is not consistent and therefore not use the neighboring pixels along the direction to determine or adjust the intensity of the selected pixel.

The determinations associated with steps 806-812 of the example operation 800 for a pixel Q along direction 404A of FIG. 4B may be expressed by Equation (11) below:

(I(A)−I(Q))*(I(Q)−I(Z))>0 (11)

Thus, the operation 800 comprises determining if the sign of the first parenthetical operation is the same as the sign of the second parenthetical operation (such as + and +OR − and −). For the example operation 800, values equaling one another are treated as not meeting the conditions of less than or greater than. In some other implementations, intensities equaling one another may be considered to satisfy the condition. Therefore, an alternative to Equation (11) may be expressed by Equation (11A) below:

(I(A)−I(Q))*(I(Q)−I(Z))≥0 (11A)

Continuing with Equation (11) for simplicity, the determinations associated with steps 802-812 of the example operation 800 for a pixel Q along the direction 404A depicted in FIG. 4B may be expressed by Equation (12) below:

G₁<Threshold, and (I(A)−I(Q))*(I(Q)−I(Z))>0 (12)

Continuing the example for directions 404B-404D through pixel Q in the mask of FIG. 4B, the determinations associated with steps 806-812 of the example operation 800 along the other directions may be expressed by Equation (13), Equation (14), and Equation (15) below:

(I(B)−I(Q))*(I(Q)−I(Y))>0 (13)

(I(C)−I(Q))*(I(Q)−I(X))>0 (14)

(I(P)−I(Q))*(I(Q)−I(R))>0 (15)

Leveraging Equations (13), (14), and (15), the determinations associated with steps 802-812 of the example operation 800 along direction 404B, direction 404C, and direction 404D depicted in FIG. 4B may be expressed by Equations (16), (17), and (18), respectively, below:

G₂<Threshold, and (I(B)−I(Q))*(I(Q)−I(Y))>0 (16)

G₃<Threshold, and (I(C)−I(Q))*(I(Q)−I(X))>0 (17)

G₄<Threshold, and (I(P)−I(Q))*(I(Q)−I(R))>0 (18)

The example operation 800 is illustrative for determining if one or more neighboring pixels are to be used in adjusting or determining the intensity of the selected pixel. For example, operations of steps 806 through 812 may comprise different operations, be in a different order, or may be combined to, for example, implement Equations (11), (13), (14), or (15). Additionally, all or portions of steps 802-812 of the example operation 800 may be performed concurrently or in a different order to, for example, implement Equations (12), (16), (17), or (18). Thus, the present disclosure should not be limited to the example operation 800.

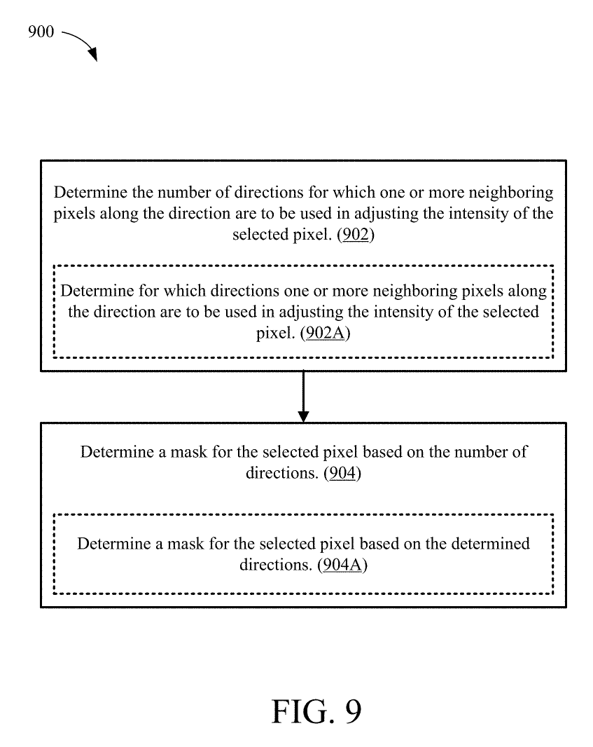

FIG. 9 is an illustrative flow chart depicting an example operation 900 for determining a mask for the selected pixel. The image signal processor 118 may first determine the number of directions for which one or more neighboring pixels along the direction are to be used in adjusting or determining the intensity of the selected pixel (902). In determining the number of directions, the image signal processor 118 may optionally determine which directions include one or more neighboring pixels to be used in adjusting or determining the intensity of the selected pixel (902A).

The image signal processor 118 then uses the number of determined directions to determine a mask for the selected pixel (904). In determining the mask based on the number of determined directions, the image signal processor 118 may use the directions determined in 902A to determine the mask (904A). While the examples are described in determining a mask for the image for a pixel, adjusting or determining the intensity of a pixel may be one or more computations without the need for selecting a mask. The masks may be representations of the one or more computations being performed to determine and apply the filtered intensity for a pixel. Thus, explanation of the masks and determining a mask is for illustrating some aspects of the present disclosure, and the present disclosure should not be limited to such specific examples.

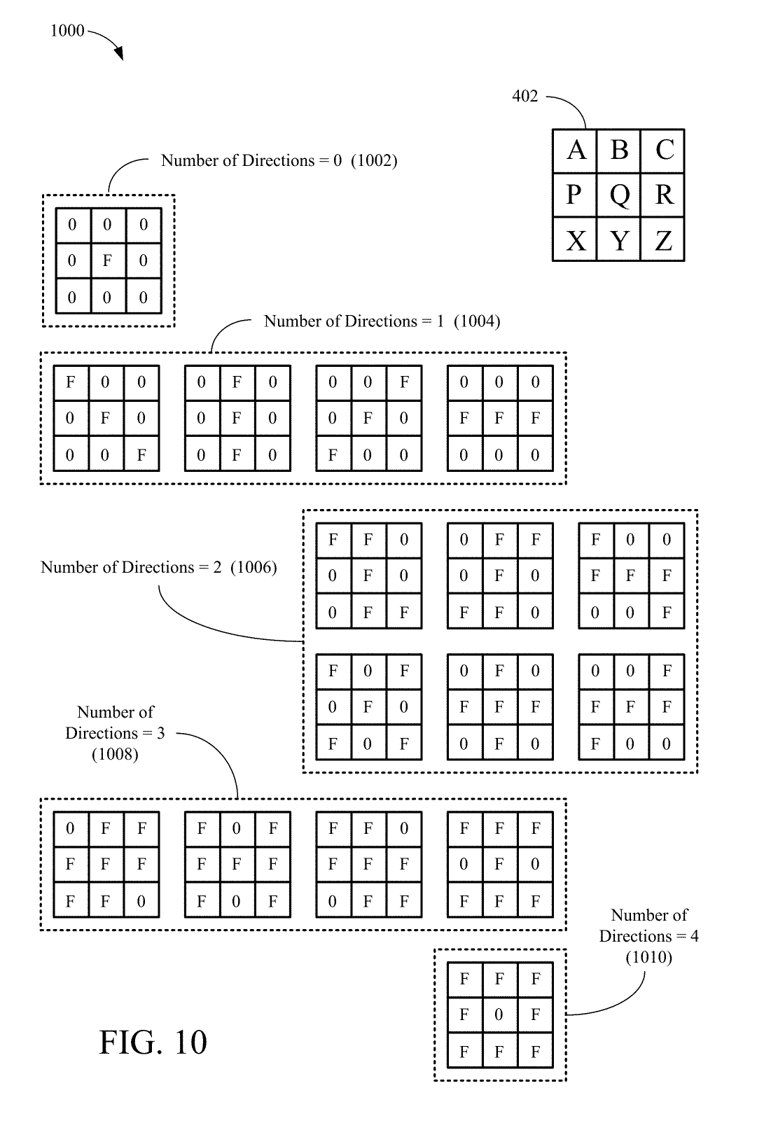

FIG. 10 is an illustration 1000 depicting example 3×3 masks for the selected pixel based on the number of directions for which one or more neighboring pixels of the selected pixel are to be used in adjusting the intensity of the selected pixel. Group 1002 includes an example mask if the number of directions is determined to be 0. The mask shows that no neighboring pixels are to be used in adjusting or determining the intensity of pixel Q (I(A)=0, I(B)=0, I(C)=0, I(P)=0, I(R)=0, I(X)=0, I(Y)=0, and I(Z)=0). F indicates a non-zero number to be used in determining the intensity. For example, if F=1 for the example mask, the intensity of pixel Q remains unchanged. Different instances of F may indicate different numbers. Therefore, each instance of F in illustration 1000 does not necessarily indicate the same number. For example, one instance of F may equal 1 while another instance of F in the same mask may equal 2 or 4. F thus indicates only that the number is not zero for the example masks.

Group 1004 includes example masks if the number of directions is determined to be 1. Group 1006 includes example masks if the number of directions is determined to be 2. Group 1008 includes example masks if the number of directions is determined to be 3. Group 1010 includes an example mask if the number of directions is determined to be 4. As shown for the example mask in group 1010, all of the neighboring pixels may be used and pixel Q might not be used in adjusting or determining the intensity of pixel Q.

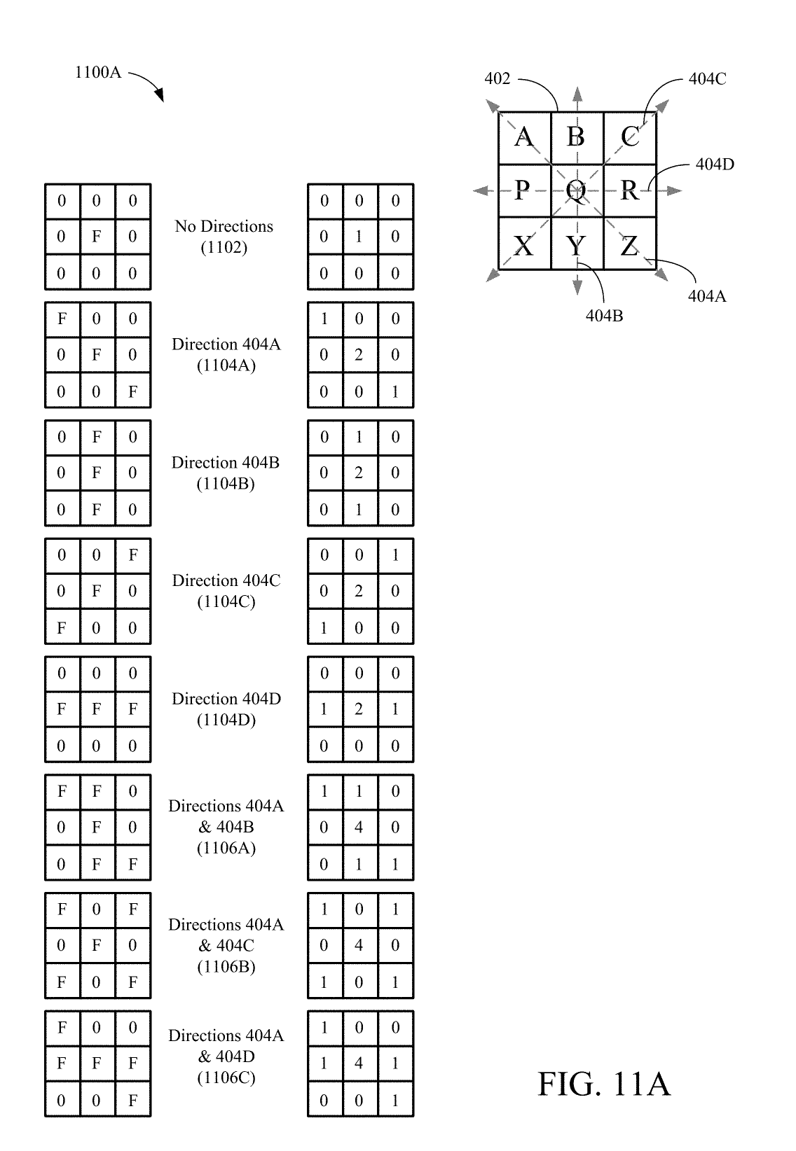

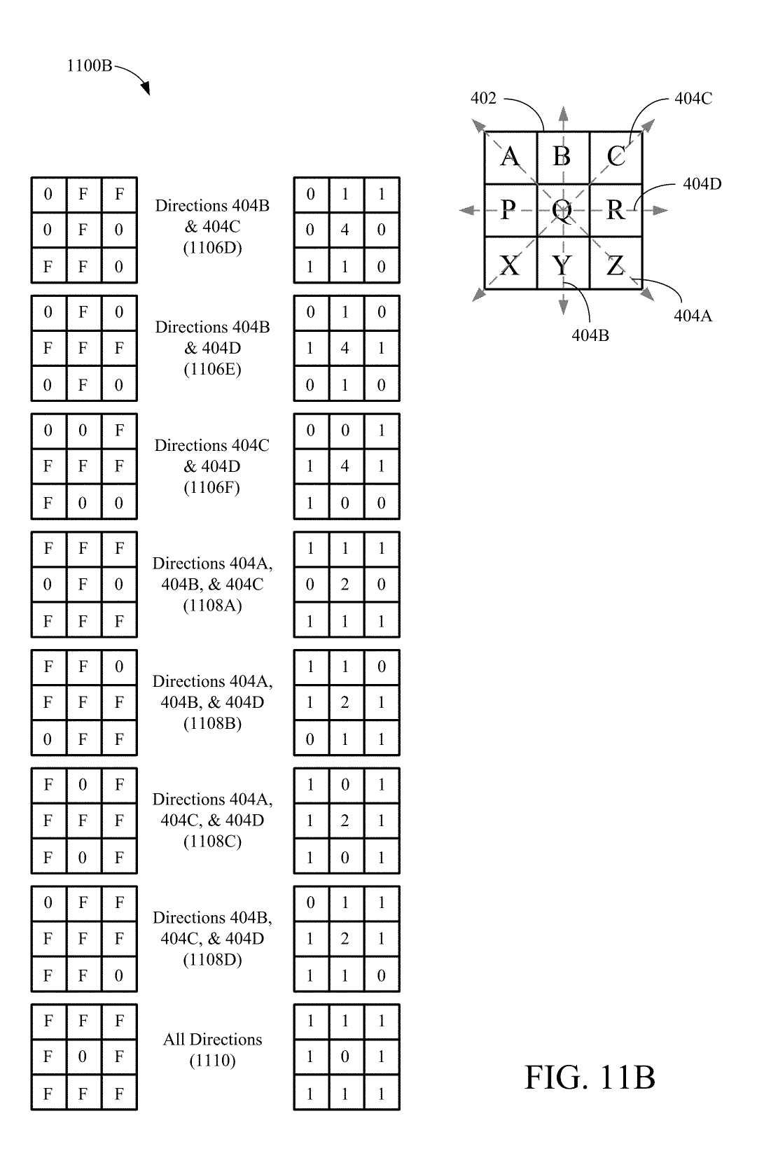

FIG. 11A is an illustration 1100A depicting example masks for the selected pixel based on which directions one or more neighboring pixels of the selected pixel are to be used in adjusting the intensity of the selected pixel. The example masks on the left in illustration 1100A are the examples provided in the illustration 1000 of FIG. 10. The example masks on the right include example values for the instances of F in the example masks on the left.

The mask 1102 indicates no directions are determined, similar to the group 1002 depicted in FIG. 10, and the intensity of pixel Q might not depend on the intensities of neighboring pixels. For example, the right example mask indicates that the intensity of pixel Q remains unchanged (I_{filtered}(Q))=I(Q)). The masks 1104A-1104D indicate one direction is determined (similar to the group 1004 depicted in FIG. 10), with the mask 1104A corresponding to direction 404A, the mask 1104B corresponding to direction 404B, the mask 1104C corresponding to direction 404C, and the mask 1104D corresponding to direction 404D.

For the example mask 1104A, the intensity of pixel Q depends on the intensities of pixel A, pixel Q, and pixel Z. In the example with values for the instances of F, the filtered intensity of Q for 1104A may be expressed by Equation (19) below:

$${I}_{filtered} ( Q ) = \frac{I ( A ) + 2 * I ( Q ) + I ( Z )}{4} \qquad ( 19 )$$

The masks 1106A-1106C indicate that two directions are determined (such as similar to a portion of the group 1006 depicted in FIG. 10, with the remainder in the illustration 1100B depicted in FIG. 11B). The mask 1106A corresponds to directions 404A and 404B, the mask 1106B corresponds to directions 404A and 404C, and the mask 1106C corresponds to directions 404A and 404D. The remainder of the mask 1106 is described below with respect to FIG. 11B.

FIG. 11B is an illustration 1100B depicting additional example masks for the selected pixel based on which directions one or more neighboring pixels of the selected pixel are to be used in adjusting the intensity of the selected pixel. Continuing discussion of the mask 1106, the mask 1106D corresponds to directions 404B and 404C, the mask 1106E corresponds to directions 404B and 404D, and the mask 1106F corresponds to directions 404C and 404D.

The mask 1108 indicates that three directions are determined (such as similar to the group 1008 depicted in FIG. 10). The mask 1108A corresponds to directions 404A, 404B, and 404C. The mask 1108B corresponds to directions 404A, 404B, and 404D. The mask 1108C corresponds to directions 404A, 404C, and 404D. The mask 1108D corresponds to directions 404B, 404C, and 404D. The mask 1110 indicates that all four directions in 402 are determined (such as similar to the group 1010 depicted in FIG. 10). As shown, in one example implementation when all directions are determined, the adjusted or determined intensity of Q might not depend on the previous intensity of Q (thus being entirely dependent on intensities of neighboring pixels).

In some implementations, the noise reduction filter for a selected pixel may be based on a stored mask (such as the example masks in depicted FIG. 10, FIG. 11A and FIG. 11B, which may be stored in a memory). In other implementations, the noise reduction filter for the selected pixel may be based on the intensities within the window or mask associated with the image portion 402. Applying the determined filter may be storing or acknowledging the determined intensity value to be the new intensity of the pixel for the processed image.

For example, the masks depicted in FIGS. 11A and 11B may be representations of the operations or calculations performed by the device in determining the filtered intensity for pixel Q. Example calculations that may be performed with respect to Equations (12) and (16)-(18) and illustrated in FIGS. 11A and 11B, may be expressed by Equations (20)-(28) below:

$$\begin{matrix}If {G}_{1} < Threshold AND ( I ( A ) - I ( Q ) ) * ( I ( Q ) - I ( Z ) ) > 0 , \\ Then \text{:} \\ SUM = I ( A ) + I ( Z ) \\ DIR = 1 \\ Proceed to ( 21 ) & ( 20 ) \\ If {G}_{2} < Threshold AND ( I ( B ) - I ( Q ) ) * ( I ( Q ) - I ( Y ) ) > 0 , \\ Then \text{:} \\ SUM += I ( B ) + I ( Y ) \\ DIR += 1 \\ Proceed to ( 22 ) & ( 21 ) \\ If {G}_{3} < Threshold AND ( I ( C ) - I ( Q ) ) * ( I ( Q ) - I ( X ) ) > 0 , \\ Then \text{:} \\ SUM += I ( C ) + I ( X ) \\ DIR += 1 \\ Proceed to ( 23 ) & ( 22 ) \\ If {G}_{4} < Thresold AND ( I ( P ) - I ( Q ) ) * ( I ( Q ) - I ( R ) ) > 0 , \\ Then \text{:} \\ SUM += I ( P ) + I ( R ) \\ DIR += 1 & ( 23 ) \\ If DIR = 0 , Then {I}_{filtered} ( Q ) = I ( Q ) & ( 24 ) \\ If DIR = 0 , Then {I}_{filtered} ( Q ) = \frac{( SUM + 2 * I ( Q ) )}{4} & ( 25 ) \\ If DIR = 0 , Then {I}_{filtered} ( Q ) = \frac{( SUM + 4 * I ( Q ) )}{4} & ( 26 ) \\ If DIR = 0 , Then {I}_{filtered} ( Q ) = \frac{( SUM + 2 * I ( Q ) )}{4} & ( 27 ) \\ If DIR = 0 , Then {I}_{filtered} ( Q ) = \frac{SUM}{8} & ( 28 )\end{matrix}$$

where DIR is the number of directions for which one or more neighboring pixels are to be used in determining a filtered intensity for pixel Q, SUM is a summation of the intensities of the neighboring pixels to be used in determining the filtered intensity for pixel Q, and the operator “+=” indicates setting the term on the left of the operator (such as DIR and SUM) as equal to the left side plus the right side. The mask may be hardware friendly so that all or portions of the operations for the mask may be implemented in hardware without significant costs or overhead. For example, the above example operations for filtering the pixel are such that the mask may be efficiently implemented in hardware. In some example implementations, to round the filtered signal without bias, the image signal processor 118 may include a rounding offset in determining a filtered intensity for a selected pixel. For example, the offsets may be included in Equations (25)-(28) (with DIR=0 meaning the intensity remains unchanged), as expressed by Equations (29)-(32) below:

$$\begin{matrix}If DIR = 1 , Then {I}_{filtered} ( Q ) = \frac{( SUM + 2 * I ( Q ) + Offset 1 )}{4} & ( 29 ) \\ If DIR = 2 , Then {I}_{filtered} ( Q ) = \frac{( SUM + 4 * I ( Q ) + Offset 2 )}{4} & ( 30 ) \\ If DIR = 3 , Then {I}_{filtered} ( Q ) = \frac{( SUM + 2 * I ( Q ) + Offset 3 )}{4} & ( 31 ) \\ If DIR = 4 , Then {I}_{filtered} ( Q ) = \frac{SUM + Offset 4}{4} & ( 32 )\end{matrix}$$

In one example, the offsets are half the value of the denominators of the above Equations (29)-(32) (i.e., Offset1=2, Offset2=4, Offset3=4, and Offset4=4). However, offsets may be other values in other implementations.

Referring again to FIG. 5, the image signal processor 118 may apply a mask centered at the pixel to selectively use the intensities of one or more neighboring pixels to determine the intensity of the center pixel. In other implementations, if the image signal processor 118 calculated values for SUM and DIR in conjunction with determining a noise reduction filter, the image signal processor 118 may use the values for SUM and DIR to determine a filtered intensity for the pixel (such as via Equations (24)-(32) above).

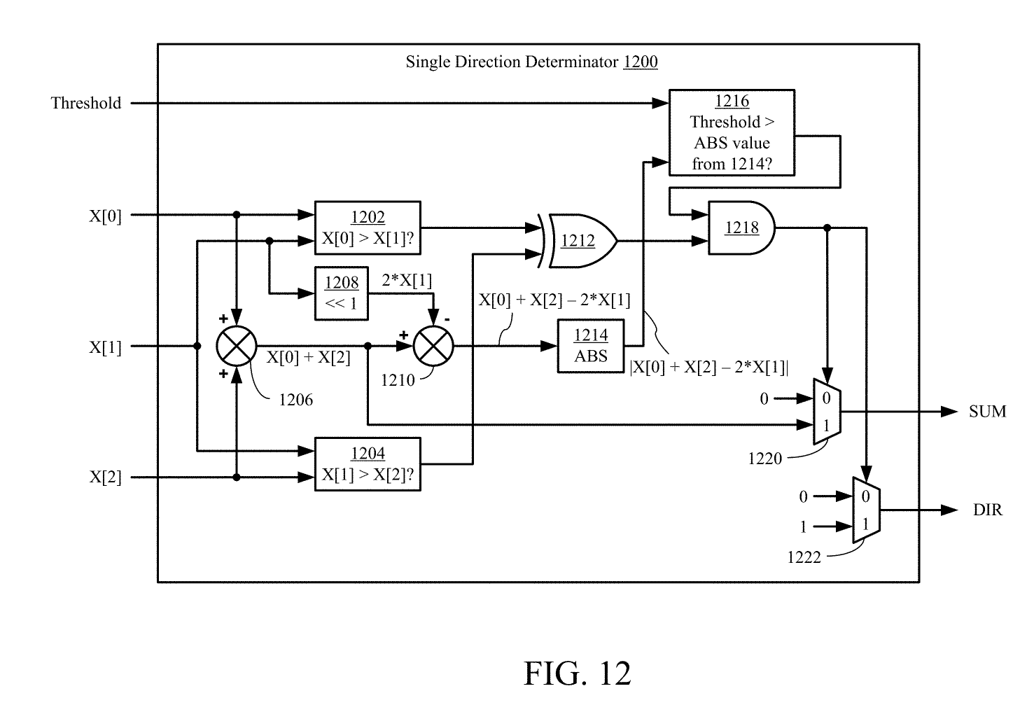

FIG. 12 is an example logic diagram of a single direction determinator 1200. The single direction determinator 1200 may be used for determining if one or more neighboring pixels of the selected pixel along a direction are to be used in adjusting the intensity of the selected pixel. For example, the single direction determinator 1200 may be configured to determine one of Equations (20)-(23) (thus for a single direction). As shown, the single direction determinator 1200 may include inputs for a Threshold (which may be determined by the device using Equation (10)) and intensities for three pixels (X[0], X[1], and X[2]). X[1] is the intensity of the selected pixel being filtered. X[0] and X[2] are intensities of a preceding pixel and a succeeding pixel of X[1] along a direction. For example, referring to the mask associated with the image portion 402 and direction 404A depicted in FIG. 4B, the preceding pixel and succeeding pixel are pixel A and pixel Z, and the selected pixel (pixel whose intensity is to be adjusted or determined) is pixel Q.

Logic block 1202 determines if X[0] is greater than X[1] (e.g., is I(A)>I(Q) for direction 404A). Logic block 1202 may output a logic 0 if X[1] is greater and output a logic 1 if X[0] is greater. Logic block 1204 determines if X[1] is greater than X[2] (e.g., is I(Q)>I(Z) for direction 404A). Logic block 1204 may output a logic 0 if X[2] is greater and output a logic 1 if X[1] is greater. As previously described regarding the example operation 800 depicted in FIG. 8, the image signal processor 118 may determine if X[0]<X[1]<X[2] or if X[0]>X[1]>X[2] (e.g., Equations (11) and (13)-(15)). Therefore, exclusive-OR (XOR) gate 1212 may receive the outputs from logic block 1202 and logic block 1204 to determine if X[0]<X[1]<X[2] or if X[0]>X[1]>X[2]. The XOR gate 1212 may output a logic 1 if either are true (1 XOR 1, or 0 XOR 0), and the XOR gate 1212 may output a logic 0 if both are false (1 XOR 0, or 0 XOR 1).

Summer 1206 determines a combination of X[0] and X[2] (such as X[0]+X[2]). For the direction 404A of the mask associated with the image portion 402 depicted in FIG. 4B, the summer 1206 determines I(A)+I(Z). Logic block 1208 multiplies X[1] by 2. Bit shifting of binary data may be used to multiply and divide by a factor of 2. For example, “<<1” indicates a bit shift left by 1 bit, which is equivalent to multiplying by 2. “>>” indicates a bit shift right, such as dividing by 2 (“>>1”), 4 (“>>2”), 8 (“>>3”), and so on.

Summer 1210 determines the difference between the output of summer 1206 and the output of logic block 1208 ((X[0]+X[2])−2*X[1]), which is similar to Equation (3). Logic block 1214 determines the absolute value or magnitude of the output of summer 1210 (|(X[0]+X[2])−2*X[1]|). Logic block 1216 compares the threshold to the output of logic block 1214 to determine if the threshold is greater than the output of logic block 1214. Logic block 1216 may output a logic 1 if the threshold is greater than the output of logic block 1214 (Threshold>|(X[0]+X[2])−2*X[1]|), and logic block 1216 may output a logic 0 if the threshold is not greater than the output of logic block 1214 (e.g., Threshold <|(X[0]+X[2])−2*X[1]|). Operation of logic block 1216 is an example implementation of determining if a gradient in intensity is less than a threshold.

Logic AND gate 1218 receives the outputs of XOR gate 1212 and logic block 1216, performs a logic AND operation, and outputs the result. Therefore, if the gradient is less than the threshold (logic 1 output by logic block 1216) AND X[0]<X[1]<X[2] or X[0]>X[1]>X[2] (logic 1 output by XOR gate 1212), AND gate 1218 outputs a logic 1. Otherwise, AND gate 1218 outputs a logic 0. In some example implementations, operation of AND gate 1218 may be similar to Equations (12) and (16)-(18).

Selection unit 1220 outputs SUM=X[0]+X[2] if AND gate 1218 outputs a logic 1, and outputs SUM=0 if AND gate 1218 outputs a logic 0. Selection unit 1222 outputs DIR=1 if AND gate 1218 outputs a logic 1, and outputs DIR=0 if AND gate 1218 outputs a logic 0. The image signal processor 118 may implement one or more of the single direction determinator 1200. If one instance of the single direction determinator 1200 is implemented, the device 100 may recursively use the single direction determinator 1200 to determine values for SUM and DIR across multiple directions. As previously described (such as in Equations (20)-(23)), values for SUM and DIR may be totaled across multiple directions. Therefore, the values for SUM and DIR depicted in FIG. 12 may be a partial SUM value and a partial DIR value, respectively.

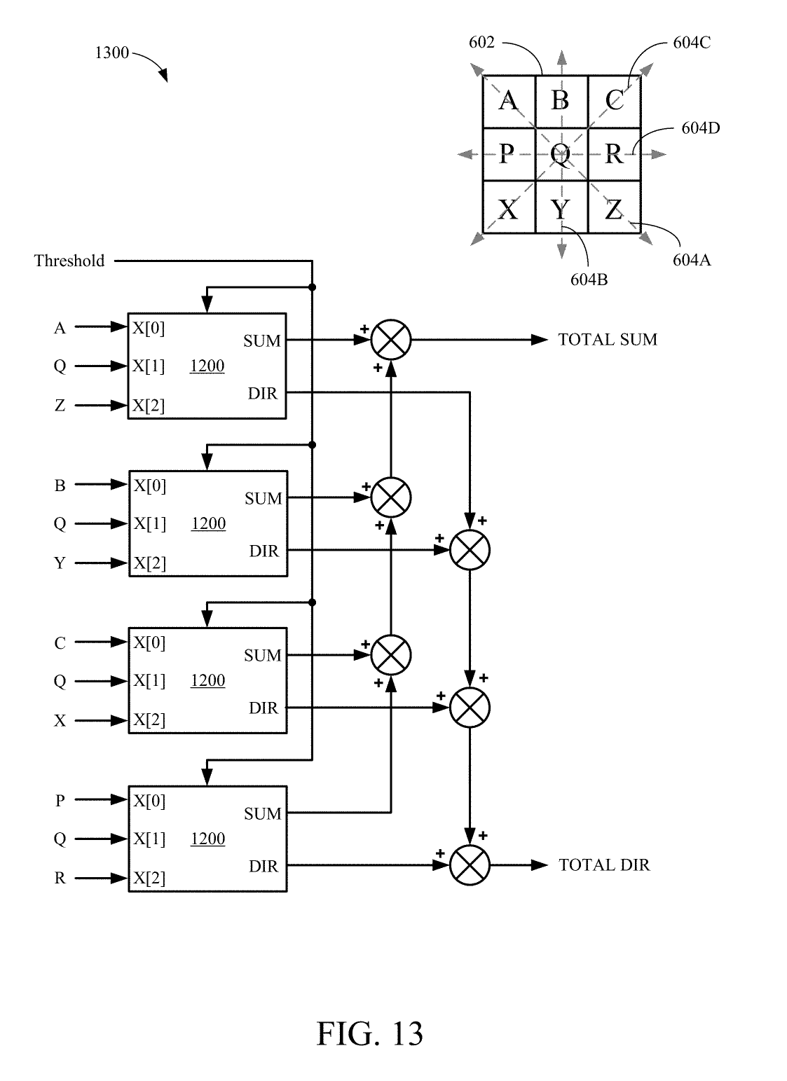

In some example implementations, multiple single direction determinators 1200 may be implemented, wherein each of the single direction determinator 1200 handles a different direction for the selected pixel. FIG. 13 is an example logic diagram 1300 depicting a system for determining a noise reduction filter to be applied to a selected pixel of the image. The example system outputs the total SUM and the total DIR that may be used in determining the filtered intensity for the selected pixel. The single direction determinators 1200 in FIG. 13 may each handle a different direction 404A, 404B, 404C, and 404D. The partial SUMs from the single direction determinators 1200 are added to determine the total SUM. The partial DIRs from the single directions determinators 1200 are added to determine the total DIR. Thus, with the total SUM and the total DIR, the device may determine the adjusted intensity for pixel Q (such as using Equations (24)-(32)).

All or a portion of Equations (24)-(32) may be implemented in hardware, software, or a combination of both. Furthermore, the techniques described herein may be implemented in hardware, software, firmware, or any combination thereof, unless specifically described as being implemented in a specific manner. For example, the described various equations, filters, and/or masks may be implemented as specialty or integrated circuits in an image signal processor, as software (such as instructions 108) to be executed by the image signal processors 118 of camera controller 110 or a processor 104 (which may be one or more image signal processors), or as firmware. Any features described may also be implemented together in an integrated logic device or separately as discrete but interoperable logic devices. If implemented in software, the techniques may be realized at least in part by a non-transitory processor-readable storage medium (such as memory 106 in FIG. 1) comprising instructions (such as instructions 108 or other instructions accessible by one or more image signal processors) that, when executed by one or more processors (such as processor 104 or one or more image signal processors in a camera controller 110), performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as processor 104 in FIG. 1 or one or more of the image signal processors 118 that may be provided within camera controller 110. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples, and any means for performing the functionality described herein are included in aspects of the disclosure.

What is claimed is:

1. A method, comprising:
receiving an image to be processed;
selecting a pixel of the image;
determining, for each of a plurality of directions through the selected pixel, a gradient in intensity based on the selected pixel and a set of one or more neighboring pixels along the corresponding direction;
determining, for each of the plurality of directions, if the set of one or more neighboring pixels is selected for adjusting the intensity of the selected pixel based on the corresponding determined gradient in intensity;
determining a noise reduction filter for the selected pixel based on the selected sets of one or more neighboring pixels; and
applying the determined noise reduction filter to the selected pixel of the image.

2. The method of claim 1, wherein the gradient in intensity comprises a gradient in luminance across the one or more neighboring pixels and the selected pixel.

3. The method of claim 1, wherein determining the gradient in intensity comprises:
determining an intensity of the selected pixel;
determining an intensity of a preceding pixel of the selected pixel;
determining an intensity of a succeeding pixel of the selected pixel; and
determining a difference between (1) a combination of the intensity of the preceding pixel and the intensity of the succeeding pixel and (2) a multiple of the intensity of the selected pixel.

4. The method of claim 3, wherein determining that the set of one or more neighboring pixels is selected comprises:
determining that a magnitude of the determined difference is less than a threshold;
when the intensity of the preceding pixel minus the intensity of the selected pixel is greater than zero, determining that the intensity of the selected pixel minus the intensity of the succeeding pixel is also greater than zero; and
when the intensity of the preceding pixel minus the intensity of the selected pixel is less than zero, determining that the intensity of the selected pixel minus the intensity of the succeeding pixel is also less than zero,
wherein at least one from the group consisting of the preceding pixel and the succeeding pixel is to be used in adjusting the intensity of the selected pixel.

5. The method of claim 4, further comprising:
determining, for the selected pixel, the threshold based on the intensity of the selected pixel.

6. The method of claim 1, wherein determining the noise reduction filter for the selected pixel further comprises:
determining the directions for which the sets of one or more neighboring pixels are selected for adjusting the intensity of the selected pixel; and
determining the noise reduction filter based on the selected sets of one or more neighboring pixels corresponding to the determined directions.

7. The method of claim 6, wherein determining the noise reduction filter for the selected pixel further comprises:
selecting a mask from a plurality of predefined masks based on the determined directions, wherein the selected mask defines which neighboring pixels along the determined directions are to be used for adjusting the intensity of the selected pixel.

8. The method of claim 6, wherein applying the noise reduction filter comprises combining the intensities of the selected sets of one or more neighboring pixels based on the determined directions.

9. The method of claim 1, wherein the noise reduction filter is linear.

10. The method of claim 1, wherein the noise reduction filter is a Laplacian based correlation filter.

11. A computing device comprising an image signal processor configured to:
select a pixel of the image;
determine, for each of a plurality of directions through the selected pixel, a gradient in intensity based on the selected pixel and a set of one or more neighboring pixels along the corresponding direction;
determine, for each of the plurality of directions, if the set of one or more neighboring pixels is selected for adjusting the intensity of the selected pixel based on the corresponding determined gradient in intensity;
determine a noise reduction filter for the selected pixel based on the selected sets of one or more neighboring pixels; and
apply the determined noise reduction filter to the selected pixel of the image.

12. The computing device of claim 11, wherein the gradient in intensity comprises a gradient in luminance across the one or more neighboring pixels and the selected pixel.

13. The computing device of claim 11, wherein the image signal processor is configured to determine the gradient in intensity by:
determining an intensity of the selected pixel;
determining an intensity of a preceding pixel of the selected pixel;
determining an intensity of a succeeding pixel of the selected pixel; and
determining a difference between (1) a combination of the intensity of the preceding pixel and the intensity of the succeeding pixel and (2) a multiple of the intensity of the selected pixel.

14. The computing device of claim 13, wherein the image signal processor is configured to determine that the set of one or more neighboring pixels is selected by:
determining that a magnitude of the determined difference is less than a threshold;
when the intensity of the preceding pixel minus the intensity of the selected pixel is greater than zero, determining that the intensity of the selected pixel minus the intensity of the succeeding pixel is also greater than zero; and
when the intensity of the preceding pixel minus the intensity of the selected pixel is less than zero, determining that the intensity of the selected pixel minus the intensity of the succeeding pixel is also less than zero, wherein at least one from the group consisting of the preceding pixel and the succeeding pixel is to be used in adjusting the intensity of the selected pixel.

15. The computing device of claim 14, wherein the image signal processor is further configured to:
determine, for the selected pixel, the threshold based on the intensity of the selected pixel.

16. The computing device of claim 11, wherein the image signal processor is configured to determine the noise reduction filter for the selected pixel by:
determining the directions for which the sets of one or more neighboring pixels are selected for adjusting the intensity of the selected pixel; and
determining the noise reduction filter based on the selected sets of one or more neighboring pixels corresponding to the determined directions.

17. The computing device of claim 16, wherein the image signal processor includes one or more integrated circuits to apply the noise reduction filter by combining the intensities of the selected sets of one or more neighboring pixels based on the determined directions.

18. The computing device of claim 11, wherein the noise reduction filter is linear.

19. The computing device of claim 18, wherein the noise reduction filter is a Laplacian based correlation filter.

20. The computing device of claim 11, wherein the image signal processor comprises one or more integrated circuits for determining the noise reduction filter.

21. The computing device of claim 11, further comprising one or more cameras coupled to the image signal processor and configured to:
capture the image; and
provide the image to the image signal processor.

22. A non-transitory computer-readable storage medium storing one or more programs containing instructions that, when executed by one or more processors of a device, cause the device to:
receive an image to be processed;
select a pixel of the image;
determine, for each of a plurality of directions through the selected pixel, a gradient in intensity based on the selected pixel and a set of one or more neighboring pixels along the corresponding direction;
determine, for each of the plurality of directions, if the set of one or more neighboring pixels is selected for adjusting the intensity of the selected pixel based on the corresponding determined gradient in intensity;
determine a noise reduction filter for the selected pixel based on the selected sets of one or more neighboring pixels; and
apply the determined noise reduction filter to the selected pixel of the image.

23. The non-transitory computer-readable storage medium of claim 22, wherein the gradient in intensity comprises a gradient in luminance across the one or more neighboring pixels and the selected pixel.

24. The non-transitory computer-readable storage medium of claim 22, wherein execution of the instructions to determine the gradient in intensity causes the device to:
determine an intensity of the selected pixel;
determine an intensity of a preceding pixel of the selected pixel;
determine an intensity of a succeeding pixel of the selected pixel; and
determine a difference between (1) a combination of the intensity of the preceding pixel and the intensity of the succeeding pixel and (2) a multiple of the intensity of the selected pixel.

25. The non-transitory computer-readable storage medium of claim 24, wherein execution of the instructions to determine that the set of one or more neighboring pixels is selected causes the device to:
determine that a magnitude of the determined difference is less than a threshold;
when the intensity of the preceding pixel minus the intensity of the selected pixel is greater than zero, determine that the intensity of the selected pixel minus the intensity of the succeeding pixel is also greater than zero; and
when the intensity of the preceding pixel minus the intensity of the selected pixel is less than zero, determine that the intensity of the selected pixel minus the intensity of the succeeding pixel is also less than zero, wherein at least one from the group consisting of the preceding pixel and the succeeding pixel is to be used in adjusting the intensity of the selected pixel.

26. The non-transitory computer-readable storage medium of claim 25, wherein execution of the instructions further causes the device to determine, for the selected pixel, the threshold based on the intensity of the selected pixel.

27. The non-transitory computer-readable storage medium of claim 22, wherein execution of the instructions to determine the noise reduction filter for the selected pixel causes the device to:
determine the directions for which the sets of one or more neighboring pixels are selected for adjusting the intensity of the selected pixel; and
determine the noise reduction filter based on the selected sets of one or more neighboring pixels corresponding to the determined directions.

28. The non-transitory computer-readable storage medium of claim 22, wherein execution of the instructions to determine the noise reduction filter causes the device to:
determine a linear Laplacian based noise reduction filter to be applied to the selected pixel of the image.

29. A computing device, comprising:
means for receiving an image to be processed;
means for selecting a pixel of the image;
means for determining, for each of a plurality of directions through the selected pixel, a gradient in intensity based on the selected pixel and a set of one or more neighboring pixels along the corresponding direction;
means for determining, for each of the plurality of directions, if the set of one or more neighboring pixels is selected for adjusting the intensity of the selected pixel based on the corresponding determined gradient in intensity;
means for determining a noise reduction filter for the selected pixel based on the selected sets of one or more neighboring pixels; and
means for applying the determined noise reduction filter to the selected pixel of the image.

30. The computing device of claim 29, wherein the means for determining the gradient in intensity is to:
determine an intensity of the selected pixel;
determine an intensity of a preceding pixel of the selected pixel;
determine an intensity of a succeeding pixel of the selected pixel; and
determine a difference between (1) a combination of the intensity of the preceding pixel and the intensity of the succeeding pixel and (2) a multiple of the intensity of the selected pixel.
